(19) United States
(12) Patent Application Publication
(10) Pub. No.: US 2009/0180137 A1
(43) Pub. Date: Jul. 16, 2009

(54) DEVICE SETTING SYSTEM, DEVICE SETTING METHOD, AND COMPUTER-READABLE RECORDING MEDIUM SAVING DEVICE SETTING PROGRAM

(75) Inventor: Naoki Kuwasaki, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/262,407

(22) Filed: Oct. 31, 2008

(30) Foreign Application Priority Data
Jan. 16, 2008 (JP) 2008-006698

(51) Int. Cl. G06F 3/12

(52) U.S. Cl. 358/1.15

(57) ABSTRACT

A device setting system comprises a host unit; and a device to be connected to the host unit. The host unit comprises a host unit controlling unit that activates the automatic setting module with a device to be connected being specified, each time the device driver is activated, requests, using the automatic setting module, the specified device to transmit device setting information, obtains, using the automatic setting module, device setting information from the specified device, and allows, using the automatic setting module, device settings based on the obtained device setting information to be reflected in the device driver. The device comprises a device storing unit that stores device setting information; and a device controlling unit that transmits the device setting information to the host unit in response to a request obtained from the host unit.

### INCORPORATION BY REFERENCE

This application is based upon and claims the benefit of priority from the corresponding Japanese Patent Application No. 2008-006698, filed Jan. 16, 2008, the entire contents of which is incorporated herein by reference.

### BACKGROUND

1. Field

The present invention relates to device setting systems, methods, and computer-readable recording medium programs, for setting an image forming apparatus, such as a printer, a facsimile machine, a copier, a scanner apparatus, a digital multi function peripheral (MFP), or other network devices (peripheral devices that operate with a device driver).

2. Description of the Background

In order to allow an image forming apparatus such as paper printers, facsimile devices, copiers, scanner apparatus, or a MFP (Multi Function Peripheral) and the like, to print, for example on paper, various print settings are performed by a microcomputer included in the image forming apparatus and printer driver software that run on a host computer that is connected to the imaging forming apparatus through an interface.

In a data terminal apparatus, which is connected to a printer to perform printing of image information, typically, when connecting the printer, a printer driver needs to be installed on the data terminal apparatus. Here, when a multi function peripheral having a printer function is used as the printer, since generally various attached devices are connected to the multi function peripheral, the attached devices also need to be set to be usable on the data terminal apparatus. This requires the data terminal apparatus to identify what type of attached device is actually being connected. For example, the attached devices can be a finisher, a reversing unit for two-sided recording, etc., and the finisher and reversing unit can also comprise a plurality of types.

In recent years, there has been an expansion of the use of computer networks. Thus, in many offices, a LAN (Local Area Network) in which a plurality of information apparatuses such as computers and printers are connected to one another is used. As computers and peripheral devices such as printers, scanners, and digital cameras have proliferated, networks such as LANs also have proliferated. By sharing a printer, a modem, and an image reader on a network, it is possible for those on the network to use a variety of apparatuses on the network.

A number of network devices, such as printers and routers, can be connected to the LAN that is used in an office or a company. In order to efficiently manage or monitor the network devices, conventionally, SNMP (Simple Network Management Protocol) have been used. In a SNMP, by using individual MIBs (Management Information Bases) on the network, one can obtain necessary information, set parameters, and the like.

For example, a device managing apparatus, e.g., a personal computer or the like, can communicate over the LAN using the SNMP protocol with devices on the LAN. The device managing apparatus thereby obtains necessary information from the MIBs with respect to the devices and uses the information for network management. Additionally, the device managing apparatus can write necessary information to the MIBs of the respective devices and thereby control the operations of the devices.

Conventionally, printing systems that communicate with a printer to obtain device information on an attached device from the printer and printer drivers to perform necessary settings are used. Printing systems also are used to determine whether there is information on the appropriate settings that is already saved, using a display of a print setting screen as a trigger, and if there is such information, settings based on the information are reflected, and if there is not, the information is saved upon printing.

Furthermore, there have been proposed data terminal apparatus wherein when an instruction to perform necessary settings to make a device of a printer apparatus that is connected to the data terminal apparatus usable is accepted, device information is requested from the printer and a device of the printer apparatus is specified with respect to a printer driver stored therein based on inputted device information. The device is thereby automatically set to be usable.

### SUMMARY

A device setting system is provided pursuant to an embodiment of the present invention. The system comprises, in an embodiment, a host unit; and a device to be connected to the host unit. The host unit comprises a host unit communicating unit that communicates with the device; a host unit storing unit that saves a device driver having an automatic setting module; and a host unit controlling unit. The host unit controlling unit activates the automatic setting module with a device to be connected being specified each time the device driver is activated. Furthermore, the host unit controlling unit requests, using the automatic setting module, the specified device to transmit setting information through the host unit communicating unit, obtains, using the automatic setting module, device setting information from the specified device through the host unit communicating unit, and allows, using the automatic setting module, device settings based on the obtained device setting information to be reflected in the device driver. The device comprises a device communicating unit that communicates with the host unit; a device storing unit that stores device setting information; and a device controlling unit that transmits the device setting information to the host unit through the device communicating unit in response to a request obtained from the host unit through the device communicating unit.

A computer-readable recording medium is provided in another embodiment of the present invention. The medium records a device setting program which is executed by a computer included in a host unit to which a device is connected. The device setting program causes the computer to perform, each time a device driver is activated, a process of: activating an automatic setting module with a device to be connected being specified; obtaining device setting information from the connected device using the automatic setting module; and allowing device settings based on the obtained device setting information to be reflected.

A device setting method is provided in still another embodiment of the present invention. The method comprises: activating, by a host unit, an automatic setting module with a device to be connected being specified each time a device driver is activated; requesting from the host unit, using the automatic setting module, the specified device to transmit device setting information through a host unit communicating unit; transmitting, in response to the request obtained from the host unit, device setting information to the host unit from the specified device through a device communicating unit; obtaining, by the host unit, the device setting information transmitted from the specified device using the automatic setting module; and allowing, by the host unit, device settings based on the obtained device setting information to be reflected in the device driver using the automatic setting module.

In this text, the terms “comprising”, “comprise”, “comprises” and other forms of “comprise” can have the meaning ascribed to these terms in U.S. Patent Law and can mean “including”, “include”, “includes” and other forms of “include”.

Additional features and advantages are described herein, and will be apparent from the following Detailed Description and the figures.

### BRIEF DESCRIPTION OF THE DRAWINGS

FIG. 1 is a diagram showing a configuration of a printing system pursuant to an embodiment of the present invention;

FIG. 2 is a block diagram showing a configuration of a host unit in the printing system;

FIG. 3 is a block diagram showing a configuration of a network printer in the printing system;

FIG. 4 is a block diagram showing a configuration of a device setting system constructed in the printing system; and

FIG. 5 is a flowchart showing steps of a device setting process in the device setting system.

### DETAILED DESCRIPTION

The present invention provides systems, methods and devices for printing. An embodiment of the present invention will now be described in detail below with reference to the drawings. It is to be understood that the present invention is not limited to the following embodiment and, therefore, modifications and changes can be made to the embodiment without departing from the spirit and scope of the present invention.

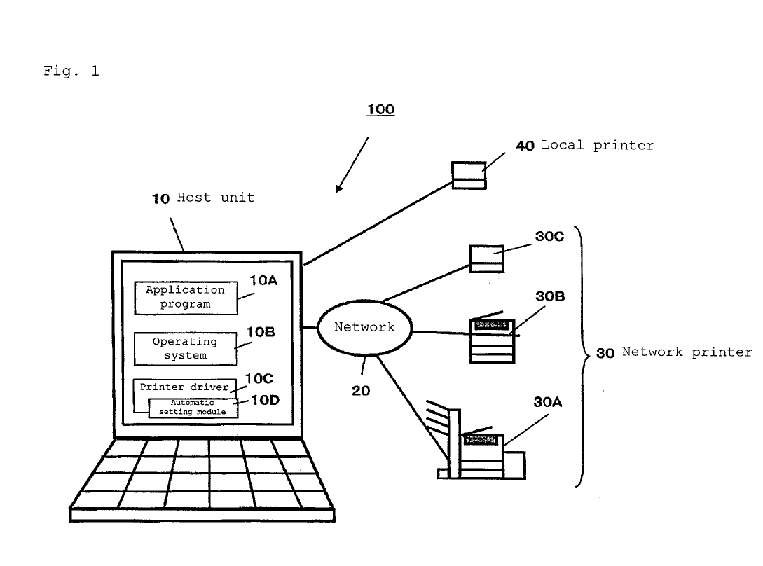

Pursuant to the illustrated embodiment of the present invention, the invention can be used in a printing system 100 having, for example, as shown in FIG. 1, a host unit 10; a plurality of network printers 30A, 30B, and 30C which are connected through a network to the host unit 10 via a network 20 such as a LAN (Local Area Network); and a local printer 40 which is locally connected to the host unit 10.

The printing system 100 uses SNMP (Simple Network Management Protocol) and thus the host unit 10 and the plurality of network printers 30A, 30B, and 30C are connected to each other according to the SNMP so as to be in communication.

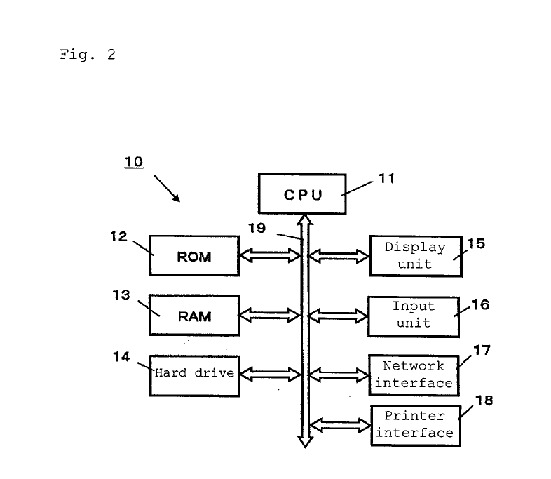

The host unit 10 can be, for example, a personal computer having an application program 10A, an operating system 10B, a printer driver 10C (device driver), and the like, installed thereon. As shown in FIG. 2, a CPU (Central Processing Unit) 11 is provided that serves as a host unit controlling unit and performs overall control of the host unit 10 and various arithmetic operations. The host unit 10 includes ROM (Read Only Memory) 12 for storing control programs and data, RAM (Random Access Memory) 13 for temporarily storing a program and data as a work area, a hard drive 14 serving as a host unit storing unit that saves various programs and data, a displaying unit 15 for displaying various information (such as a liquid crystal display), an inputting unit(s) 16 (such as a keyboard, a mouse, etc.), for inputting various instructions, a network interface 17 serving as a host unit communicating unit (such as a LAN card), that establishes connection to the network 20, and a printer interface 18 serving as another host unit communicating unit that locally connects the local printer 40. All of these can be interconnected via a bus 19. An SNMP manager for performing communication according to the SNMP by the network interface 17 is installed on the CPU 11.

In the printing system 100 the printer driver 10C having an automatic setting module 10D is saved on the hard drive 14 of the host unit 10. The network printers 30 (30A, 30B, and 30C) or the local printer 40 are assigned to the printer driver 10C.

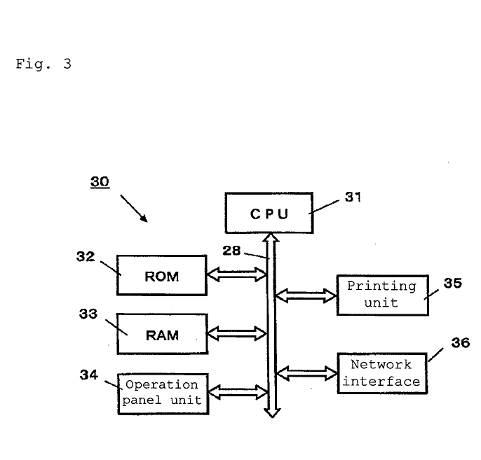

In the network printers 30 (30A, 30B, and 30C), which are devices to be connected to the host unit 10, as shown in FIG. 3, a CPU 31 is provided. The CPU 31 serves as a device controlling unit that provides overall control of the device and various arithmetic operations. A ROM 32 is provided for storing a control program and data such as device setting data, as well as a RAM 33 that temporarily stores a program and data as a work area. An operation panel unit 34 is provided for displaying various information and to input various instructions. A printing unit 35 is also provided for printing various data on recording medium, such as paper, using a known image forming process such as an electrophotographic process. And a network interface 36 is provided as a device communicating unit, such as a LAN card, establishing a connection to the network 20 interconnected via a bus 37. A SNMP module 38 (38A, 38B, 38C, . . . ) for performing communication according to the SNMP by the network interface 36 is installed on the CPU 31.

In the local printer 40, the CPU, ROM, RAM, operation panel unit, and printing unit are interconnected via a bus with the network printer 30A, 30B, or 30C. Additionally, in the local printer 40, a local connection interface, such as a USB (Universal Serial Bus), that locally connects to the host unit 10 is connected to the bus and the local printer 40 has a PJL (Print Job Language) module 41 that communicates with the host unit 10.

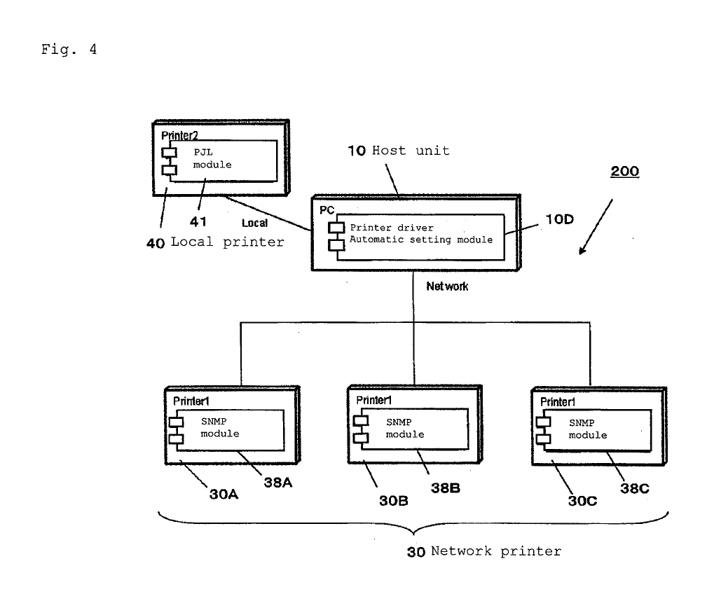

In the printing system 100, a device setting system 200 having a configuration such as that shown in FIG. 4 is provided by the host unit 10, the plurality of network printers 30A, 30B, and 30C which are network-connected to the host unit 10 via the network 20 such as a LAN (Local Area Network), and the local printer 40 which is locally connected to the host unit 10. Specifically, the device setting system 200 shown in FIG. 4 comprises the host unit 10 in which the printer driver 10C having the automatic setting module 10D is saved on the hard drive 14 and the network printers 30 (30A, 303B, and 30C) which are connected to the host unit 10 and which function to communicate device setting information to the automatic setting module 10D in response to a request from the automatic setting module 10D, or the local printer 40.

In the device setting system 200, each time the printer driver 10C is activated, the CPU 11 of the host unit 10 activates the automatic setting module 10D with either the network printer 30 (30A, 30B, or 30C) or the local printer 40 being specified as a device to be connected to the host unit 10. Using the automatic setting module 10D, device setting information from the connected network printer 30 (30A, 30B, or 30C) or the local printer 40, is obtained and references the obtained device setting information to allow device settings based on the referenced device setting information to be reflected, when displaying a user interface on the display unit 15.

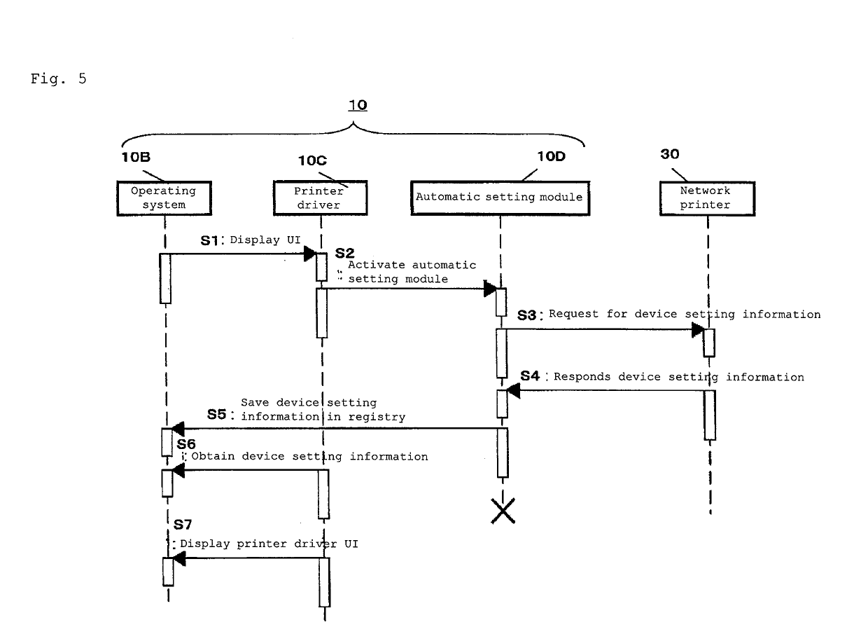

Pursuant to the device setting system 200, the CPU 11 of the host unit 10 performs a device setting process in cooperation with a device setting program read into the RAM 13 from the hard drive 14 and according to the steps shown in the flowchart illustrated in FIG. 5.

Specifically, in the device setting system 200, when the printer driver 10C is activated, the CPU 11 of the host unit 10 requests, using the operation system 10B, the printer driver 10C to display a user interface, such as a print setting or device setting dialogue, on the display unit 15 (step S1). Then, the CPU 11 provides necessary information, such as an IP address of a network printer 30 (30A, 30B, or 30C) to be connected by the printer driver 10C, to the automatic setting module 10D to activate the automatic setting module 10D (step S2). Using the activated automatic setting module 10D, the CPU 11 requests device setting information (step S3) for the network printer 30 (30A, 30B, or 30C) specified through the network interface 17 using, for example, the SNMP.

The printer 30A, 30B, or 30C specified in step S3 receives the request for device setting information from the host unit 10 through the network interface 36. The CPU 31 responds to the request for device setting information using the SNMP module 38 (38A, 38B, or 38C) and responds to the host unit 10 through the network interface 36 (step S4).

The CPU 11 of the host unit 10 obtains, using the automatic setting module 10D, the device setting information from the connected network printer 30 (30A, 30B, or 30C) through the network interface 17. The CPU 11 writes the obtained device setting information into a registry (which is saved on the hard drive 14) related to the printer driver (step S5). Then, when the CPU 11 determines that the writing of the device setting information into the registry has been completed, the CPU 11 obtains the device setting information from the registry in the hard drive 14 (step S6) and allows device settings based on the obtained device setting information to be reflected in the activated printer driver and displays a printer driver user interface on the display unit 15 (step S7).

In the device setting system 200, when the printer driver 10C is activated, the automatic setting module is activated to obtain the latest device setting information on a printer main unit. Thus, without user awareness, the device settings of the printer driver 10C can always match those of the printer main unit. Accordingly, setting errors of the printer diver 10C can be eliminated. In addition, the system allows the user to operate the printer driver 10C with the same device settings as those of the printer. Hence, as described above, in the printing system 100, each time a printing process is performed, the latest device setting information can be obtained to perform necessary configurations without the user being concerned using the device setting system 200. For example, the settings of the paper feed tray and where to eject paper, that cannot be specified, upon printing are eliminated. In addition, the system allows the determination of whether an IP address specified in the printer driver 10C is valid.

Although in the above description the automatic setting module 10D obtains, using the SNMP, device setting information from the connected network printer 30 (30A, 30B, or 30C), it should be noted that this can be performed by any means. What is required is that the means by which this is performed can communicate with the printer; for example, when obtaining device setting information from the local printer 40, the PJL module 41 is used.

Although device setting information obtained by the automatic setting module 10D is saved in a registry of the host unit 10, the device setting information may be converted into an XML file or the like or may be converted into some kind of binary data.

The device setting program is provided by a computer-readable recording medium such as a ROM, a hard drive, a flexible disk, a memory card, or a magneto-optical disk. Then, by the device setting program being read into the host unit from the recording medium, instructions are sent to each component of the host unit to cause each component to perform a process.

From the above-described embodiment, the present invention can be summarized, in part, as follows. A device setting system according to an embodiment of the present invention comprises a host unit; and a device to be connected to the host unit. The host unit comprises a host unit communicating unit that communicates with the device; a host unit storing unit that saves a device driver having an automatic setting module; and a host unit controlling unit. The host unit controlling unit activates the automatic setting module with a device to be connected being specified each time the device driver is activated. Furthermore, the host unit controlling unit requests requests, using the automatic setting module, the specified device to transmit device setting information through the host unit communicating unit, obtains, using the automatic setting module, device setting information from the specified device through the host unit communicating unit, and allows, using the automatic setting module, device settings based on the obtained device setting information to be reflected in the device driver. The device comprises a device communicating unit that communicates with the host unit; a device storing unit that stores device setting information; and a device controlling unit that transmits the device setting information to the host unit through the device communicating unit in response to a request received from the host unit through the device communicating unit.

When the host unit controlling unit references device setting information received from the host unit communicating unit to display a user interface, the host unit controlling unit may allow device settings based on the referenced device setting information to be reflected in the device driver. The device driver is, for example, a printer driver that performs various print settings of a network printer which is connected through the network to the host unit as the device. At this time, the host unit controlling unit can obtain device setting information by Simple Network Management Protocol.

According to another embodiment of the present invention, using a computer-readable recording medium, a device setting program can be recorded which is executed by a computer included in a host unit to which a device is connected. The device setting program causes the computer to perform, each time a device driver is activated, a steps of: activating an automatic setting module with a device to be connected being specified; obtaining device setting information from the connected device using the automatic setting module; and allowing device settings based on the obtained device setting information to be reflected.

The present invention also provides a device setting method. According to still another embodiment of the present invention, the method comprises: activating, by a host unit, an automatic setting module with a device to be connected being specified each time a device driver is activated; requesting from the host unit, using the automatic setting module, the specified device to transmit device setting information through a host unit communicating unit; transmitting, in response to the request obtained from the host unit, device setting information to the host unit from the specified device through a device communicating unit; obtaining, by the host unit, the device setting information transmitted from the specified device, using the automatic setting module; and allowing, by the host unit, device settings based on the obtained device setting information to be reflected in the device driver, using the automatic setting module.

According to embodiments of the present invention, when the device driver is activated, the automatic setting module is activated to obtain the latest device setting information on the device main unit. Thus, the device settings of the device driver can always match those of the device main unit without user awareness, and accordingly, setting error of the device driver can be eliminated. In addition, the user can always operate the device driver with the same device settings as those of the device.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A device setting system comprising:
a host unit;
a device to be connected to the host unit;
the host unit comprising:
a host unit communicating unit that communicates with the device; a host unit storing unit that saves a device driver having an automatic setting module; and
a host unit controlling unit that activates the automatic setting module with a device to be connected being specified each time the device driver is activated, requests, using the automatic setting module, the specified device to transmit device setting information through the host unit communicating unit, obtains, using the automatic setting module, device setting information from the specified device through the host unit communicating unit, and allows, using the automatic setting module, device settings based on the obtained device setting information to be reflected in the device driver; and
the device comprising:
a device communicating unit that communicates with the host unit;
a device storing unit that stores device setting information; and
a device controlling unit that transmits the device setting information to the host unit through the device communicating unit in response to a request obtained from the host unit through the device communicating unit.

2. The device setting system according to claim 1, wherein when the host unit controlling unit references device setting information obtained through the host unit communicating unit to display a user interface, the host unit controlling unit allows device settings based on the referenced device setting information to be reflected in the device driver.

3. The device setting system according to claim 1, wherein the device driver is a printer driver that performs various print settings of a network printer which is connected through the network to the host unit as the device.

4. The device setting system according to claim 3, wherein the host unit controlling unit obtains device setting information using Simple Network Management Protocol.

5. A computer-readable recording medium recording a device setting program which is executed by a computer included in a host unit to which a device is connected, the device setting program causing the computer to perform, each time a device driver is activated, the steps of:
activating an automatic setting module with a device to be connected being specified;
obtaining device setting information from the connected device using the automatic setting module; and
allowing device settings based on the obtained device setting information to be reflected.

6. The computer readable recording medium of claim 5 wherein the device is a printer.

7. A device setting method comprising:
activating, by a host unit, an automatic setting module with a device to be connected being specified each time a device driver is activated;
requesting from the host unit, using the automatic setting module, the specified device to transmit device setting information through a host unit communicating unit;
transmitting, in response to the request obtained from the host unit, device setting information to the host unit from the specified device through a device communicating unit;
obtaining, by the host unit, the device setting information transmitted from the specified device, using the automatic setting module; and
allowing, by the host unit, device settings based on the obtained device setting information to be reflected in the device driver, using the automatic setting module.

8. The computer readable recording medium of claim 7 wherein the device is a printer.
